(19) United States
(12) Patent Application Publication
(10) Pub. No.: US 2001/0046247 A1
(43) Pub. Date: Nov. 29, 2001

(54) EXCIMER LASER SYSTEM

(76) Inventor: RAYMOND A. HARTMAN, SAN DIEGO, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/141,238

(22) Filed: Aug. 27, 1998

Related U.S. Application Data
(60) Provisional application No. 60/094,402, filed on Jul. 28, 1998.

(51) Int. Cl. H01S 3/22; H01S 3/223

(52) U.S. Cl. 372/57

(57) ABSTRACT

An improved excimer laser system for use in medical procedures such as transmyocardial laser revascularization is disclosed. The laser uses a number of novel design features to reduce the footprint and weight of the laser over prior designs; e.g., an improved recirculating fan design that employs a non-contacting magnetic coupling between fan motor and fan, and an improved laser diffusion mixer at the output.

### CROSS-REFERENCE TO RELATED APPLICATIONS

This non-provisional utility patent application depends on a U.S. Provisional Patent Application filed under 37 C.F.R. §1.53(B)(2), entitled “Laser System”, naming Raymond A. Hartman as inventor, filed Jul. 28, 1998, Serial No. 60/094,402.

### BACKGROUND OF THE INVENTION

1. Field of Invention

The present invention relates generally to an improved excimer laser for treatment of medical applications, particularly for use in performing transmyocardial laser revascularization (TMLR)

### SUMMARY OF THE INVENTION

The present invention is for an improved excimer (gas) pulsed laser system that has numerous advantageous over prior laser systems, including but not limited to: a smaller size footprint, a lighter weight, elimination of bottlenecks associated with replenishing the laser optical cavity chamber thorough an improved fan motor drive assembly inside the laser chamber, the elimination of complicated solid state switching and motor control devices, and numerous other advantages express and implied from the present invention. One of the consequences of these improvements is the design of a excimer laser system that weights only 275 lbs. (as opposed to prior designs weighing 660 lbs.), with a smaller footprint, having dimensions of only 18″×32″×36″ (as opposed to prior designs having outer dimensions of 25″×40″×43″) and with a gas chamber that can be recharged by hospital personnel (as opposed to prior designs that require a technician).

The system is characterized by combining all the elements and components necessary for practicing TMLR into a configuration suitable in a hospital operating room.

The above described and many other features and attendant advantages of the present invention will become apparent by reference to the following detailed description when considered in conjunction with the accompanying drawings.

### BRIEF DESCRIPTION OF THE DRAWINGS

Detailed description of preferred embodiments of the invention will be made with reference to the accompanying drawings.

FIG. 1 is a schematic of the overall operation of the device.

FIG. 2 is a cross-sectional view of the laser of FIG. 1.

FIG. 3 is a cross-section of the magnetic coupling for the fan assembly of the laser.

FIG. 4 is a view of the lenses of the lens assembly of the laser.

FIG. 5 is a schematic view of the final assembly.

### DETAILED DESCRIPTION OF THE PREFERRED EMBODIMENTS

The specification is a detailed description of the best presently known mode of carrying out the invention. This description is not to be taken in a limiting sense, but is made merely for the purpose of illustrating the general principles of the invention. The section titles and overall organization of the present detailed description are for the purpose of convenience only and are not intended to limit the present invention.

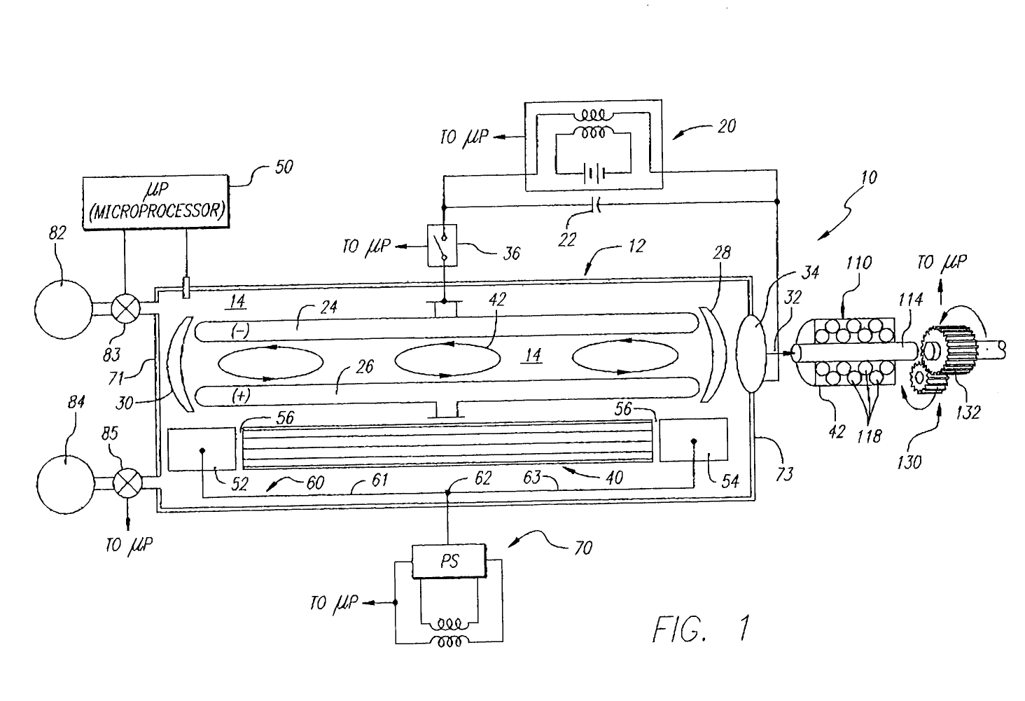

FIG. 1 discloses a schematic view of the overall operation of a laser delivery system in accordance with the present invention. In a preferred embodiment the system includes a gas laser, preferably a pulsed gas laser employing XeCl gas and having the following parameters, which have been found suitable for TMLR procedures: a lasing wavelength of 308 nm, a pulse repetition rate of 240 Hz max., a pulse width (FWHM) of 20-40 ns nominal, an output energy of between 0-100 mJ/pulse (and preferably between 20-40 mJ/pulse on a fresh gas fill), with an operating energy of about 9 mJ/pulse, an electrical input power of 220 V at 50/60 Hz, and a gas reservoir that has a supply for up to 1 year before recharging. In addition, as explained further herein, the output delivery piece is a rotating fiberoptic, that rotates at about 1300 rpm, having an adjustable depth of 0.5 cm to 2.5 cm. Further details for the handpiece are found in co-pending patent application Ser. No. 08/943,961, filed on Oct. 6, 1997, incorporated by reference herein. In other preferred embodiments, other suitable molecules of gas may be employed to produce different wavelengths of laser light output using the teachings of the present invention, e.g., such as XeBr, XeF, KrCl, KrF, ArF and F₂, which have wavelengths of 282, 351, 222, 249, 193, 157 nm, respectively, or between approximately 157 nm to 351 nm.

Referring to FIG. 1, a laser system 10 has a metal housing containing a laser gas chamber 14, which contains XeCl gas and trace amounts of assorted other corrosive gases such as hydrochloric acid at about 3 atm. (44 psi) pressure. The gas contains molecules of gas that are pumped to an higher potential energy state by the application of an external energy source, e.g. power supply 20 (via capacitor bank 22) acting to discharge electrons between cathode 24 and anode 26. The electric discharge pumps energy into the laser gas so the gas molecules achieve a so-called population inversion. When the molecules are in the appropriate state of population inversion, then the condition for lasing can occur. For excimer lasers, the excited molecules are in fact an association between an excited atom with another atom in a ground state called a dimer. Given the requirement that lasing losses do not exceed the gains and a suitable Fabry-Perot cavity (laser chamber) is present as a waveguide, the excited population inversion molecules begin to undergo stimulated emission, each molecule emitting a quantum of energy according to Planck's Law, in an avalanche of emissions. The stimulated emission is further amplified by mirrors positioned at ends of the laser chamber, e.g., mirrors 28, 30, resulting in an optical cavity that amplifies radiation as the photon particles and waveforms resonating in the optical cavity induce the remaining population inversion to undergo stimulated emission. The net result is to yield stimulated emission of photon energy that is all in the same direction, frequency and phase. One of the two mirrors 28, 30 in the laser chamber, e.g., half-mirror 28, is a half-mirror to allow some of the stimulated emission light to escape outside the chamber during lasing. Typically a laser beam 32 is output with an angle of about 3° angle of divergence, which can be shaped by a suitable lens assembly 34 to be received by a fiber optic for delivery to a patient. The gas laser may be either a continuous wave laser, or, preferably, a pulsed laser. Further, though gas lasers are relatively inefficient, typically having a few percent efficiency, in the medical application field the power output is sufficient for efficiency not to be an issue.

In general, the repetition rate of the laser firing is determined by the rate at which energy is pumped in by electromagnetic discharge between the anode and cathode. In a preferred embodiment, the maximum pulse repetition rate is 240 Hz.

As shown in FIG. 1, a laser housing 12 has a gas chamber 14, storing a gas mixture, which in a preferred embodiment of the excimer laser is XeCl gas with trace amounts of other gases, at about 3 atmospheres pressure. The gas is pumped with energy to create a population inversion upon electric discharge from between cathode 24 and anode 26, whenever energy from power supply 20, which is stored in capacitor bank 22, is dumped to the laser, such as by the switching on of a power switch 36, which is a high current electron or vacuum tube, e.g., a Thyratron. The Thyratron vacuum tube switch 36 is designed to operate with a 240 Hz switching rate, conducting up to 12,000 amps at between 15-22 V. Other suitable power switches, including semiconductor power switches such as SCR's, may be employed in lieu of the Thyratron and as additional switches between the capacitor 22 and power source 20 to condition the battery as it charges the capacitor. The capacitor bank 22 comprises a plurality of capacitors, connected in parallel to store the most charge. Within the laser gas chamber 14 exists a longitudinally extending fan 40 that recirculates air lengthwise along the gas chamber, in order to ensure that the XeCl lasing gas is not over taxed.

Suitable pressure and temperature monitoring instruments 46, suitably read by a microprocessor 50, which also monitors and controls the overall system 10, may be employed to monitor the pressure and temperature inside the laser chamber 14. Preferably the gas pressure is kept between 38-52 psi. Monitoring of instruments by the processor 50 is at least at or above the Nyquist sampling rate for electronic components and preferably about once per second for Thyratron over-temperature, high-voltage power supply temperature and chamber gas pressure. Instrument monitoring inside the chamber is suspended when there is discharge between anode and cathode, and during laser firing.

The axial flow fan 40, as shown in FIG. 1, extends parallel with the anode and cathode 22, 24, which are parallel to one another. The fan 40 may recirculate the XeCl gas at up to 60 mph throughout the chamber, as indicated by arrows 42. Fan 40 is driven at its ends by hermetically sealed DC drive motors 52, 54 with a non-contacting coupling 56, as indicated by the lack of a direct mechanical connection between fan 40 and drive motors 52, 54. A significant bottleneck is eliminated from prior designs by employing a hermetically sealed DC electric motor inside the laser chamber to drive the recirculating fan 40 with a non-mechanical contact, such as a magnetic coupling. In some inferior prior designs, a motor external to the laser gas chamber drove a fan by direct mechanical contact between the motor shaft and fan axis, which required complicated sealing that increased the size and complexity of the fan, and drove up the overall cost of the laser system.

The motors 52, 54 driving the fan 40 are DC motors kept in synchronization by employing a split fork Y-shaped wire 60, that carries electric power to the DC motor. Split fork Y-shaped wire 60 has branch wires 61, 63 equidistant in length from the midpoint point 62 where the wire, which carries current from power supply 70, enters the laser chamber at its midsection. The wire 60 is preferably nickel or nickel plated, due to the corrosive gaseous environment inside chamber 14. Indeed, the corrosive environment inside an excimer laser will destroy most organic compounds so that metal is preferably used as a material inside gas chamber 14. By using a wire having an equidistant split where it branches into two wire leads as the power lead line (i.e., having equal arms as shown), the voltage or current wave from the power supply 70 is received by both DC motors 52, 54 approximately simultaneously, resulting in an inexpensive means for synchronizing the motors. Other forms of synchronization are also within the scope of the invention, such as using AC synchronous or induction motors.

Turning attention now to FIGS. 1, 2 and 3, there is shown further details concerning the drive fan 40 and fan drive motors 52, 54. The fan 40, which may be any fan, is shown as a mixed axial flow fan having forward curved radial tip vanes, driven by a fan shaft 41. The fan motors 52, 54, situated inside the laser chamber, but hermetically sealed from the laser chamber atmosphere, are situated at each end of the fan drive shaft 41, and drive the fan shaft through a non-contact magnetic coupling or driving portion 56, as shown in FIG. 3. A magnetic material disk portion 310 is directly attached to and driven by a motor shaft 312 inside the hermetically sealed chamber housing the motor 310, and forms a first driving portion. A hermetic feedthrough 318 allows electric power line 60 to supply the motor 310. The first magnetic motor disk driving portion 310 is made of a strong magnet, such as a permanent magnet having a high magnetic permeability, e.g. a ferromagnet or ferrimagnet. On the opposite side of a barrier 322, which is transparent or translucent to magnetic flux and preferably made of a ceramic or non-eddy current metal, lies a corresponding second magnetic driven portion, driven disk 330, which is rotated by the forces generated by the magnetic flux from the first magnetic driving portion, in a non-contacting manner. Thus, the disk driving portion 310, connected to the fan motor shaft 312, can rotate the driven disk 330, connected to the fan shaft 41, through a magnetic coupling, without the necessity of a direct mechanical connection between motor(s) 52, 54 and fan 40. The driven disk 330 is physically attached to the fan shaft 41, which turns the fan impeller blades. The barrier 322, which keeps the motor driven disk 330 from contact with the corrosive lasing gas in chamber 14, is a ceramic or non-eddy current metal. This barrier layer also forms a barrier to excessive eddy currents forming in this layer, were it to be made of ferrous metal.

The fan design of the present invention, and the elimination of a direct mechanical coupling from a motor outside the laser chamber to a recirculating fan within the laser chamber, as in certain prior designs, is a significant improvement in the design of gas lasers, such as excimer lasers. The elimination of such a direct mechanical coupling from outside the laser chamber, as in prior designs, eliminates performance bottlenecks associated with certain shaft seals used to prevent the laser chamber gases, which are highly corrosive, from seeping to the outside. These seals often become the bottlenecks in running the laser system, which in turn necessitates a lower laser firing repetition rate and higher overall costs.

Further regarding the non-mechanical coupling between the motor driving the recirculating fan inside the gas laser chamber and the fan, though in the preferred embodiment a magnetic coupling is used between the fan and fan motor(s), in general any sort of non-contacting coupling may be used. In addition, the fan motor may be deposed outside the laser chamber, so long as there was access for the magnetic coupling between fan motor and fan. Thus, if the fan motors 52, 54 and their respective magnetic couplings 56 of FIG. 1 were disposed outside laser chamber 14, the magnetic lines of flux would have to enter the gas chamber 14 in order to have the fan motors turn the fan drive shaft 41. To this end a quartz or ceramic window (or any other material window transparent or translucent to magnetic flux, especially rotating lines of flux) would have to be built into the laser gas chamber housing ends 71, 73. Hence, using for example the embodiment of FIG. 3, the driving magnetic disk portion 310 of the magnetic coupling would be disposed outside the laser chamber, and could communicate, via lines of magnetic flux, with driven magnetic disk portion 330 of the magnetic coupling inside the gas chamber 14 through these quart or ceramic windows built into the housing ends 71, 73, and thus rotate the fan.

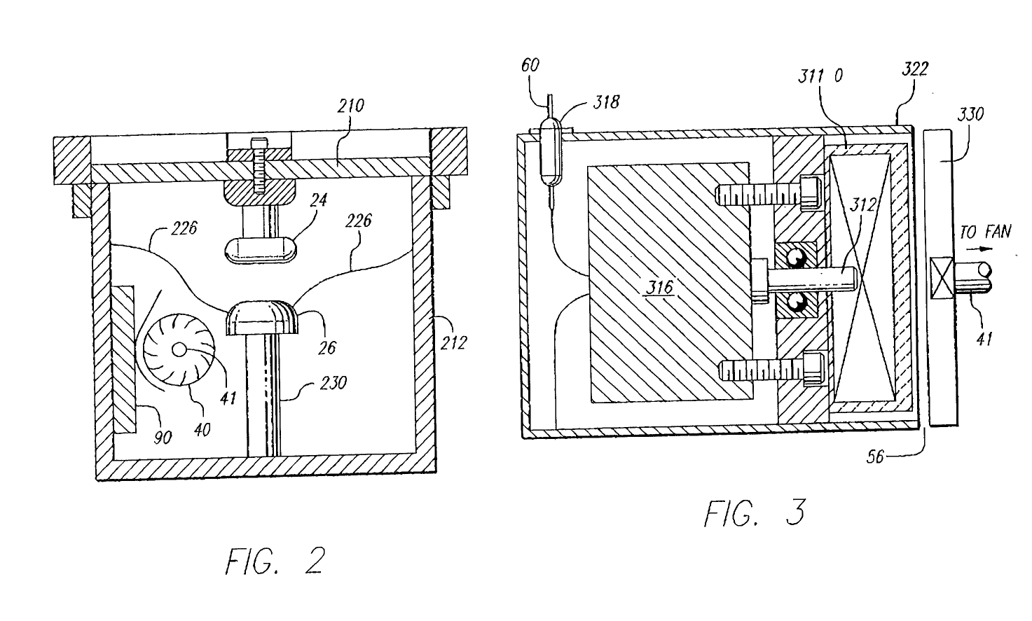

Turning attention again to FIG. 2, there is shown an axial cross-section of the laser chamber, showing the cathode 24, which generates the electron discharge that travels to the anode 26. An insulating plate 210 insulates the cathode 24 from the chamber housing 212. The anode 26 is connected by electron discharge lines 226 to a return path to complete the circuit. An anode mount 230 supports the anode along the length of the chamber. A fan motor mount bracket 240 provides support for the fan and fan motor.

Regarding the gas changing system, there is shown in FIG. 1 a lasing gas reservoir tank 82, connected from outside the gas chamber 14 with an in-line solenoid controlled valve 83 in a conduit leading to the chamber, for recharging the laser chamber periodically (e.g., every 6-12 months) with new lasing gas, such as XeCl gas and suitable other trace gas components. The valves and gas changing procedure may be automated by the microprocessor 50 running the laser system. Another solenoid valve controlled tank 84, which may be separate as shown or inline with the lasing gas reservoir tank 82, provides a chemical getter that reacts with the toxic components found in the XeCl gas to neutralize these toxic components when exchanging gas. Suitable chemical getters include basic compounds such as lye, NaOH, KOH or other suitable bases.

Further regarding the laser system, as shown in FIG. 1, each of the power supplies 20, 70, which power the capacitor 22 and DC drive fan motors 52, 54, may be electrically isolated from the outside, such as by using isolation amplifiers, e.g. transformers or an optical coupling, in order to better protect human life from high-voltage transients in the system. The entire laser system may be housed on a wheeled stand, 18″×32″×36″, as it is lightweight, weighing only about 275 lb., considered light for a gas laser system.

FIG. 5 shows the laser system in final assembly form, having a console 502, including I/O such as a keyboard, a cart frame 504 in the form of a chassis for supporting the laser system internally, which is supported on a chassis having a plurality of support levels holding the laser housing 12, the capacitor bank 22, the power supply 570 (which may contain more than one power supply, as appropriate), the gas reservoir tank 82, and the other components described in connection with FIG. 1, and as needed, to form a compact, portable assembly. The entire assembly of FIG. 1, as shown schematically in FIG. 5, may easily fit on a cabinet having the dimensions of 18″×32″×36″, and weight only 275 lbs. A handle 506 is provided on the cart, with wheels 508 for mobility, a footpedal 510 as an auxiliary ON/OFF switch, and an interface output 512, which may have a plurality of ports for suitable fiber optic and other delivery devices.

Regarding the fiber optic delivery portion of the invention, there is shown in FIG. 1 a optical microbender dispersion diffuser or mixer 110 at the output of the laser. In prior designs, laser pulses were broadened in pulse width and decreased in amplitude by running laser light pulses through about 2 meters (over 6 feet) of fiber optic, relying on the long length of the fiber optic to disperse the pulses. This adds to the overall dimensions of the device. In the instant invention, the same effect is achieved in a much more compact space of several inches, about 6 inches. A sleeve 112 envelopes the fiber optic 114 and compresses the fiber optic with beads or bearings of lead shot 118, or similarly soft material. The sleeve compresses the lead shot 118 onto the outside cladding of the fiber optic 114, thereby introducing microstresses in the fiber optic that result in the pulses being homogenized as they travel through the optical fiber waveguide mixer 110.

As the more diffused pulsed laser light is emitted from the end of optical microbender diffuser/mixer 110, it enters, via a coupling that preferably is simply an air gap, a rotating optical fiber waveguide 130. Rotating fiber optic waveguide 130 is driven by suitable drive means, such as shown conceptually by gearing 132, to rotate at about 1300 rpm. The subject matter of a fiber optical delivery handpiece for the present invention is described in co-pending patent application Ser. No. 08/943,961, filed on Oct. 6, 1997, incorporated by reference herein.

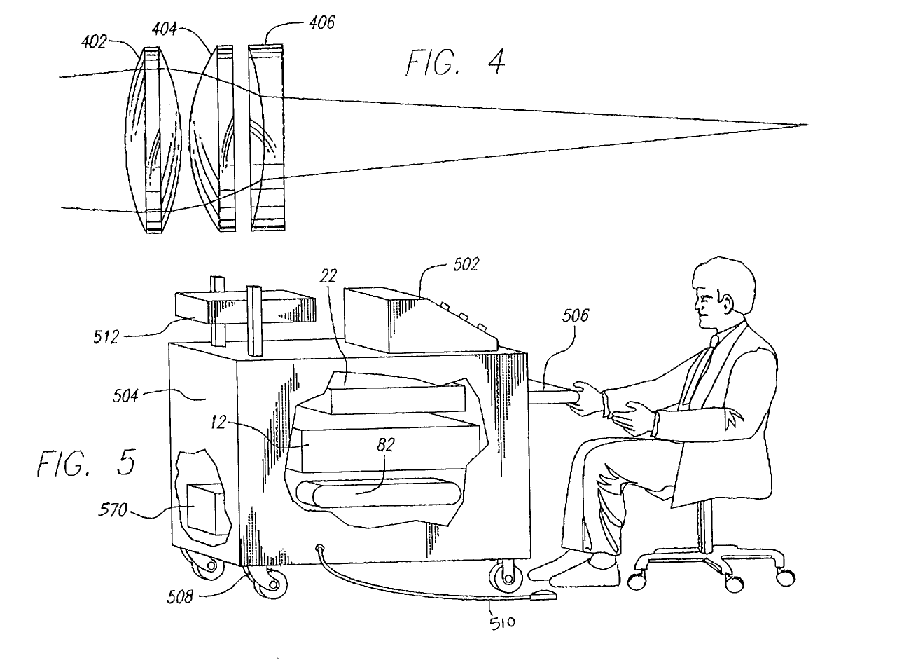

Turning now to FIG. 4, there is shown an anamorphic condenser lens assembly for shaping the radiation output from laser half-mirror 28 to couple light more efficiently into the fiber optic end 114 of the diffuser 110. The output from the laser chamber 14 is generally not circularly symmetrical (in fact, it is rectangular), while the fiberoptic delivery fiber is circular. For the most efficient transfer of optical energy, the output beam from the laser must be shaped to have a radiation pattern that matches the fiber geometry, and the conical angle of divergence of the beam must be made smaller, to better fit lased light onto the smaller diameter of the fiber. To this end, an anamorphic lens may be employed (e.g., a lens having differing curvatures in two directions) to shape any asymmetric radiation pattern into a more symmetric radiation pattern. A condenser lens may be used to focus the beam to a point source for entry into the fiber optic, at the appropriate angle of incidence. Further, as the light exits the laser chamber 14, it is reflected upwards of 45° so that the light may be delivered more readily to a fiber optic delivery system that resides at an angle to the laser chamber, and is disposed above the laser chamber on the chassis as shown in FIG. 5. Thus in FIG. 4 there are shown a first collimating and condensing piano convex lens 402, a second lens 404 and a third concave lens 406, which suitably shape and reduce the laser beam output.

Although the present invention has been described in terms of the preferred embodiments above, numerous modifications and/or additions to the above-described preferred embodiments would be readily apparent to one skilled in the art. It is intended that the scope of the present invention extends to all such modifications and/or additions and that the scope of the present invention is limited solely by the claims set forth below.

I claim:

1. A gas laser system comprising:
a gas laser chamber for lasing;
a fan inside said chamber for recirculating the gas in said gas chamber;
a motor driving said fan,
a non-mechanical coupling between said motor and said fan, said non-mechanical coupling transmitting power from said motor to drive said fan.

2. The invention according to claim 1, wherein:
said non-mechanical coupling is a magnetic coupling.

3. The invention according to claim 2, wherein:
a shaft connected to said motor and a shaft connected to said fan, and
said magnetic coupling comprises a first magnetic driving portion mechanically attached to said motor shaft and a second magnetic driven portion mechanically attached to said fan shaft.

4. The invention according to claim 1, wherein:
said motor driving said fan is disposed inside said gas chamber.

5. The invention according to claim 4, wherein:
said fan has vanes disposed along the longitudinal length of said gas chamber, and further comprising an anode and a cathode in said gas chamber for electric discharge inside said chamber, said anode and cathode disposed parallel to one another, said fan parallel to said anode and cathode.

6. The invention according to claim 1, wherein:
said gas laser system is a excimer gas laser system outputting pulsed wave radiation having the following properties: a wavelength of between 157 nm to 351 nm, a pulse width of between 20-40 ns, a pulse energy of up to 100 mJ/pulse, and a pulse repetition rate of up to 240 Hz.

7. The invention according to claim 1, wherein:
said gas laser system is an excimer gas laser using as the lasing gas medium gas selected from the group consisting of: F₂, ArF, KrCl, KrF, XeBr, XeCl or XeF.

8. The invention according to claim 1, wherein:
said fan has vanes disposed along the longitudinal length of said gas chamber, and further comprising an anode and a cathode in said gas chamber for electric discharge inside said chamber, said anode and cathode disposed parallel to one another, said fan is in between said anode and cathode;
said fan has an axial shaft;
said motor driving said fan is disposed at the end of said fan axial shaft, wherein said motor is a DC motor.

9. The invention according to claim 8, further comprising:
a second motor for driving said fan, said second motor disposed at the end of said fan axial shaft opposite to the first motor driving said fan, said second motor a DC motor;
a Y-shaped electrical lead connected to said first and second DC motors, said electrical lead connected to a power supply outside said gas chamber and feeding both DC motors;
wherein said Y-shaped lead has equidistant arms where the lead splits into two portions.

10. The invention according to claim 5, further comprising:
a capacitor bank charged by an external power supply;
a switch connecting said capacitor to said anode and cathode to form a circuit;
said switch being closed to discharge said capacitor through said anode and cathodes;
wherein said laser may fire.

11. The invention according to claim 10, wherein:
said switch is a vacuum tube, operating at up to 240 Hz.

12. The invention according to claim 11, wherein:
said vacuum tube is a Thyratron.

13. The invention according to claim 1, further comprising:
a laser diffuser comprising a fiber optic, a plurality of beads of material compressed outside said fiber optic;
said gas laser system is a pulsed wave radiation gas laser system;
wherein said laser light pulses are dispersed by said laser diffuser.

14. The invention according to claim 1, wherein:
said gas laser system is portable, and has a total weight of less than 300 lbs.

15. The invention according to claim 14, wherein:
said portable gas laser system has dimensions of 18″×32″×36″, and is housed on an assembly having wheels.

16. A pulsed gas laser system comprising:
a laser gas chamber, having an opening for the output of pulses of laser light;
a laser diffuser comprising a fiber optic for receiving said pulsed laser light output of said laser, a plurality of beads of shot compressed outside said fiber optic;
wherein said laser light pulses are dispersed by said laser diffuser.
